(19) United States
(12) Patent Application Publication
(10) Pub. No.: US 2015/0206230 A1
(43) Pub. Date: Jul. 23, 2015

(54) Internet, Goods, Services, Location, Shipping and Assembly

(71) Applicant: John Milner McCary, SR., Birmingham, AL (US)

(72) Inventor: John Milner McCary, SR., Birmingham, AL (US)

(21) Appl. No.: 13/999,135

(22) Filed: Jan. 22, 2014

(51) Int. Cl. G06Q 30/08; G06Q 10/08

(52) U.S. Cl. CPC G06Q 30/08; G06Q 10/087

(57) ABSTRACT

The present invention is an enhanced negotiation online website system and method that purchasers and suppliers can locate, purchase and sell goods and/or services, but the online website system does not directly match, suggest or rate any goods and/or service provider. The geographical location of the supplier, supplier's good(s), purchaser's delivery address or address where supplier's service is to be performed is provided specifically by the purchaser and supplier. The shipping cost to various locations, numbers of goods, by various shipping modes, can quickly be calculated and known by the purchase and seller. The purchasers and suppliers can communicate and negotiate back and forth with each other through the format mechanism of the online website system. The purchaser and/or supplier can sub-assemble or sub-contract out goods and/or services.

### FIELD OF THE INVENTION

The present invention relates to the online sales of goods and services with the location of the possible purchaser and supplier of the goods or services known and the capability to sub-assemble goods and/or services

### BACKGROUND OF THE INVENTION

Currently sellers and buyers can connect in two main ways over the internet. Online auction sites such as eBay, enables sellers to post auction listings on the website that a bidder can make offers to try and purchase the listed items. There are other listing services, such as Craigslist, that seller can post classified items for sale where there is usually not a bidding process. Most all online goods listing websites do not show the actual geographical location of the purchaser's location for desired goods and/or services, the location of where goods and/or services of the supplier are located. Also there are services offered to the possible purchasers that are or can be shown on the website by potential suppliers. The possible purchaser of the goods may decide to pick up or make other shipping arrangements if there was a quick way to get the actual location and the shipping cost of goods. In many instances the supplier may have goods or services located at various locations.

In most instances repairs, construction or other services, or combination of services and goods or parts used in the services performed, will entail the purchaser or supplier to have to travel to the decided location to have the services performed, and possibly goods also shipped or picked up. There would be the need for the purchaser and supplier to have up-to-date shipping and goods/services location information. Also some goods suppliers and service providers want to choose who, when and where they may want to do provide goods and services. There may be excellent part or full time service providers who only want to work on certain applications or particular items to repair.

Additionally there may be the need for the purchaser to sub-assemble or sub-contract goods and/or services. An example can be where the purchaser may need to repair or build and there will be multiple goods and/or service needed that may be supplied by more than one supplier of goods and/or services.

### SUMMARY OF THE INVENTION

An online system website and method where a supplier can place or list goods and/or services and a purchaser can request and purchase goods and/or services. The goods and/or services can be sold on an auction basis or more conventional mostly set price basis. In Application US 2012/0284135, Nov. 8, 2012 and Application US 2012/0284, Nov. 8, 2012, both Hunter; Ian et al., the location of the purchaser and supplier is provided “by utilizing automatic detection location data from the user' computing devices”. Utilizing the location of the purchaser's and supplier's computers does not really give current valid information as to the actual location of the purchaser, the purchaser's desired delivery address and or actual location(s) of supplier's goods and/or service location(s). The actual geographical location of the goods and/or place where services are to be performed is usually given by the supplier and the geographical location of the purchaser of the goods and/or services is usually specified by the purchaser on the online website system. The supplier may have the same good and/or service at multiple locations and/or the purchaser may want similar goods and/or services at various locations. The estimated shipping costs in different shipping modes and/or shipping distance can in most cases be quickly calculated by the purchaser and/or supplier(s) on the online system website. There is an online communication mechanism by the online website between the possible purchaser and the supplier as to the possibility of shipping alternatives. An example may be where the purchaser may specify the desired and/or allowable shipping time and/or shipped to location with possible adjustment in the purchase price. In this example the purchaser gives the supplier ten more days to ship than originally specified in the initial offer and the purchaser would be willing to pick up at the suppliers location or maybe the shipping truck terminal instead of having the good shipped to the purchaser's actual location. Another example may be where if an Item is picked up there may be less shipping packaging cost and the supplier may reduce the purchase price.

The online website system would request goods and service suppliers to register in those categories of goods and services that the suppliers of goods and/or services would want to be notified by the online website system and possibly respond to requesting purchasers in those particular categories. The online website system would allow goods and service providers to only respond to those requests that they would want to respond.

The online system website also has the mechanism to facilitate the purchaser to assemble, or contract multiple suppliers to produce a service or services and/or goods. A supplier can also be able to sub-assemble or sub-contract out a service or services and/or goods supplied to a purchaser, where the purchaser may or may not be on the online website system. In the assembling or sub-assembling or sub-contracting there are various specification categories levels and communication that the online website system provides as options between and/or to the purchaser and supplier.

### BRIEF DESCRIPTION OF THE INVENTION

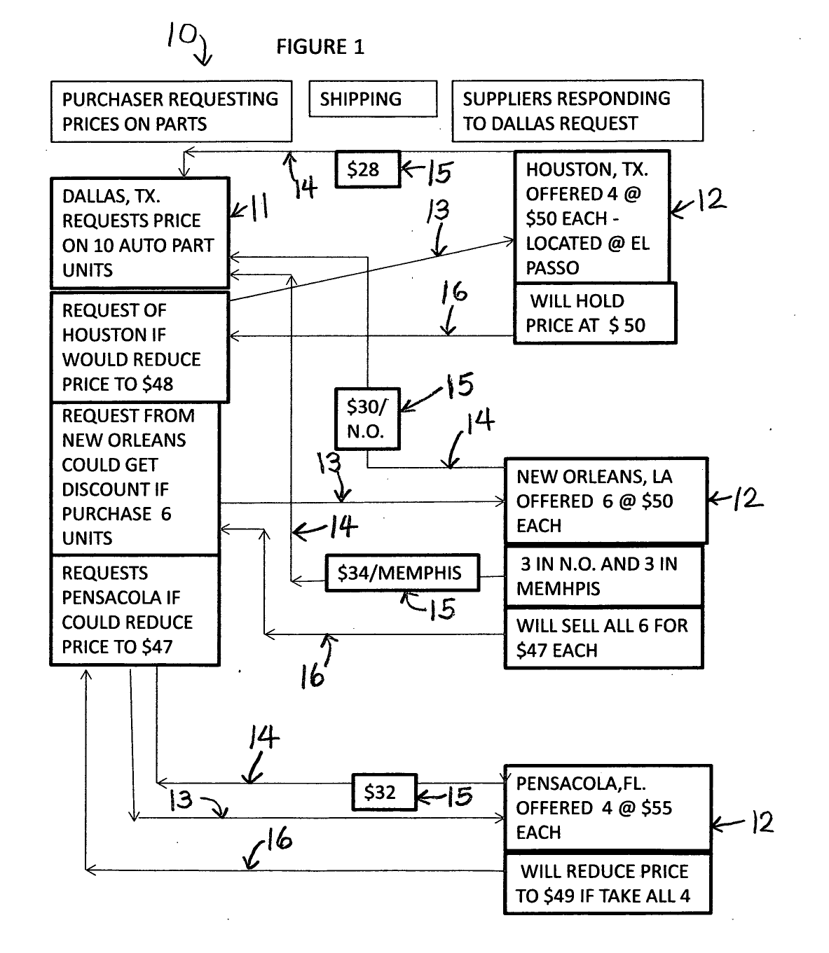

FIG. 1 shows in a diagram form the online sales system example where a purchase requests prices on a number of goods in an open negotiation format.

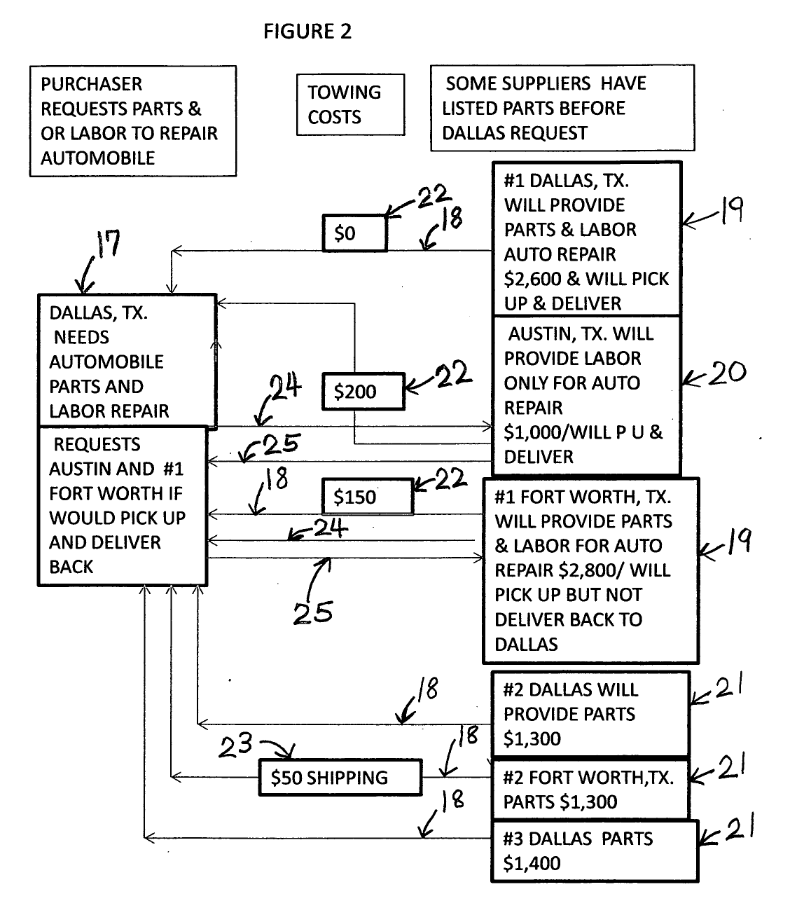

FIG. 2 shows in a diagram form the online sales system where purchaser requests parts and labor where suppliers respond to purchaser's request.

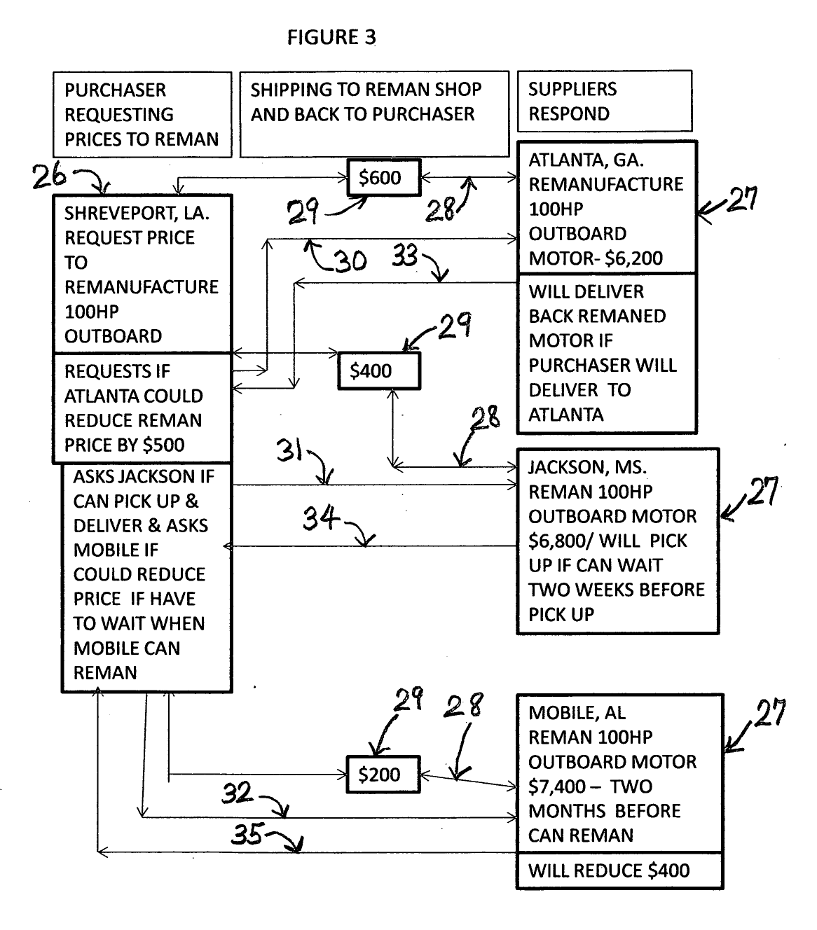

Shown in FIG. 3, in a diagram form, is an example in the online sales system where purchaser requests a price from suppliers for a service.

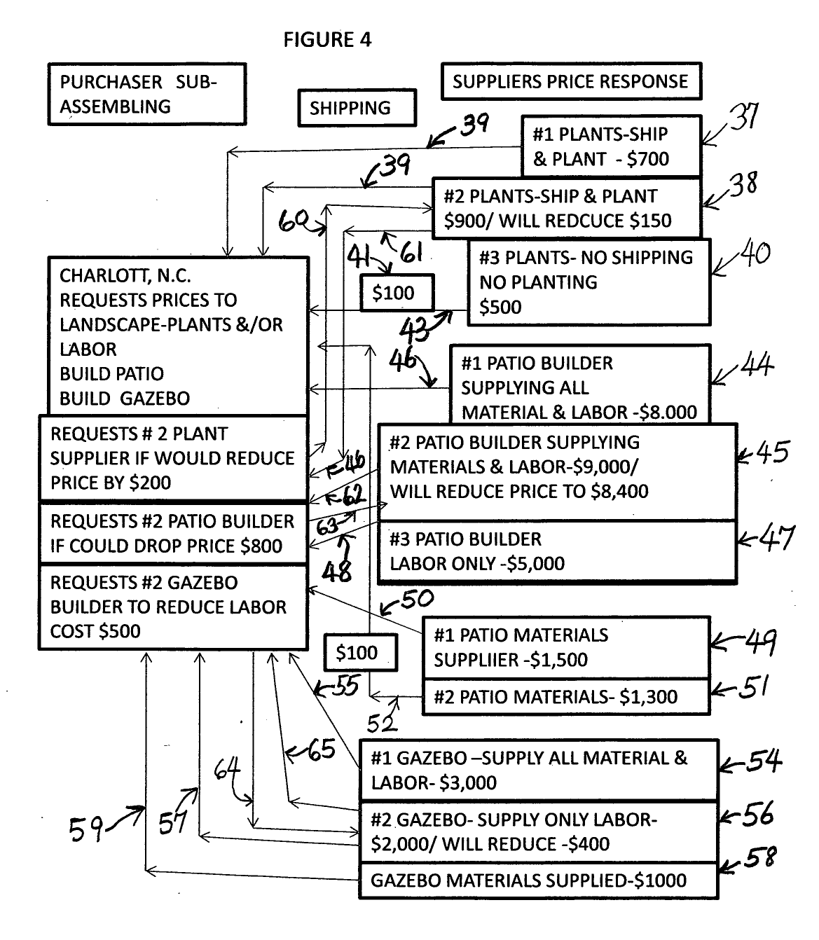

FIG. 4 shows in a diagram form the online sales system the purchaser sub-assembling from various supplier's goods and/or services.

### DETAILED DESCRIPTION OF THE INVENTION

Shown in FIG. 1 in a diagram format 10 is an example of the online website sales system used where the purchaser, Dallas, desires to locate and purchase automobile parts and is requesting suppliers to respond to Dallas request 11. Suppliers are prompted by the online system of the particular auto parts category line the suppliers have registered themselves on the online system, and various suppliers either suppliers that have current listings on the online system or those suppliers who may just respond to purchaser's request, respond to Dallas request 12. The purchaser, Dallas, request various price reductions 13 after receiving the quantity and prices of goods offered 14 from the suppliers and the shipping costs 15. The suppliers respond to the purchaser's request for price reductions 16.

FIG. 2 shows in a diagram form an example of the online sales system where a purchaser request parts and/or labor for an automobile repair 17. Suppliers respond 18 to the potential purchaser's request supplying parts and labor 19, one supplier supplying just labor 20 and other suppliers supplying parts only 21, and automobile towing 22 or shipping costs 23. Purchaser makes request to Austin and Fort Worth suppliers if they would pick up and deliver back automobile 24. Austin and Fort Worth then respond back to purchaser, Dallas 25.

Shown in FIG. 3, in a diagram form, is another example of the online website system where the purchaser is requesting parts and labor repair or remanufacturing of an outboard motor 26 and various suppliers 27 respond to the remanufacture request 28 with the associated shipping cost 29 to ship the outboard motor to the remanufacturer and back to the purchaser. The purchaser the requests of supplier Atlanta if could reduce the remanufacturing price 30, asks supplier Jackson if could pick up and deliver back 31 and asks supplier Mobile if could reduce price if gave Mobile more time to remanufacture 32. Atlanta responds back that will pick up but not offered to reduce price 33. Jackson responds that will pick up if purchaser can wait two weeks before pick up 34. Mobile will reduce price by $400, 35.

FIG. 4 shows in a diagram form the purchaser using the online website system to sub-assemble labor and/or materials to build a patio with a gazebo and have landscaping 36. #1 and #2 plant suppliers 37 and 38 will ship and plant at prices offered to the purchaser 39. # 3 plant supplier 40 will sell plants but not ship, shipping cost 41, and will not plant the plants 42 with price response to purchaser 43. #1 patio and #2 patio builders 44 and 45 will provide labor and materials in response to purchaser's request 46. #3 patio builder will supply labor only 47 in response 48 to purchaser. #1 Patio building materials supplier 49 will supply materials to purchaser at a price 50. #2 patio materials supplier 51 will supply materials 52 but will not ship, shipping cost 53. #1 gazebo builders 54 will provide all materials and labor to the purchaser 55, where #2 gazebo builder 56 will supply only labor 57 in response to the purchaser. A gazebo materials supplier 58 responds with a price 59. Purchaser requests #2 plant supplier to reduce price by $200, 60 and #2 plant supplier responds that will reduce price by $150, 61. Purchaser requests #2 patio builder to reduce price by $800, 62. #2 patio builder responds with a price reduction of $600, 63. Purchaser request #2 gazebo builder to reduce price by $500, 64. #2 gazebo builder will reduce price by $400, 65.

1. An enhanced negotiation online website system and method where purchasers and suppliers can locate, openly negotiate, and purchase and sell goods and/or services comprising:
suppliers specify and register on the online system the goods and/or services online website system category(s) that suppliers would want to be notified online when a purchaser has made a request for goods and/or services in that category(s), and
a. category(s) is the classification system to define and organize the divisions of goods and services; and
b. there are multiple categories of goods and services and the categories can expand as suppliers offer, and purchasers request, additional new categories of goods and/or services ; and
c. supplier's categorized goods and/or services can be listed for sale at an initial set price to potential purchasers, and/or suppliers can sell categorized goods and/or services in an auction format where potential purchasers can bid on the goods and/or services; and
d. listing goods and/or services would entail that potential purchasers and suppliers can locate by category and view on the online system information on and/or visuals of goods and/or services placed by suppliers that are offered for sale; and
e. potential purchasers request on the online system categorized goods and/or services that the purchaser would like to purchase at an offered price from suppliers and/or purchaser would like to purchase in an auction format where suppliers may bid to offer the goods and/or services to the purchaser; and
f. the online website system attempts to find the closest category, or starts a new category, to categorize either purchaser's requests, and/or supplier's offers, goods and/or services; and
g. an online system registered supplier can offer goods and/or services when a purchaser places a request for goods and/or services; and
h. the registered category suppliers do not have to have current goods and/or services listed on the online system to offer goods and/or services to requesting purchasers; and
i. the online website system does not directly match any purchaser with a supplier; and
j. the online website system does not choose, suggest, or rate any supplier's performance of a potential supplier's offered categorized goods and/or services requested by a purchaser, but purchasers can rate or give recommendations for particular suppliers, which ratings, recommendations or supplier offered references and/or previous ratings are or can be posted with suppliers on the online website system; and
k. suppliers can also rate individual purchasers on the online website system as to the purchasers promptness to pay for supplied goods and/or services; and
l. the geographical location of the supplier, supplier's good(s), purchaser's delivery address or address where supplier's service is to be performed for the purchaser, is provided specifically by the purchaser and supplier, and shown with the suppliers and purchasers listings, offerings or requests, unless the purchaser request the purchaser's location not be shown on the purchaser's listing or offer; and
m. the shipping cost to various locations; various optional shipping locations and shipping costs; various numbers of goods shipped and shipping cost; by various shipping modes, can quickly be calculated, with total shipping cost on groups of goods and/or service(s) are calculated and can be known by the purchase and seller; and
n. shipping packaging cost can be requested by the purchaser to be provided by the supplier; and
o. purchasers and suppliers can communicate and negotiate back and forth with each other through the online website system sales open negotiation dialog format including but not limited to shared information including alternative shipping methods or delivery locations, alternative locations of supplier's goods and/or services, alternative quantity and quality of goods and/or services, drawings, surveys, photographs, or other information that may promote additional sales closing options offered in the negotiated sales process; and
p. the online website system has the mechanism(s) for a purchaser to divide a proposed desired service into multiple suppliers, including a separate supplier of labor and a separate supplier of materials, used in conjunction to provide the service, which includes construction projects, repair, renovations and/or landscaping projects where labor and materials are both usually required to provide these types of services; and
q. the online website system has the mechanism(s) for a supplier to divide a proposed service to a purchaser into multiple suppliers, including a separate supplier of labor and a separate supplier of materials, used in conjunction to provide the service, which includes construction, repair, renovations and/or landscaping projects where labor services and supplied materials are both usually used to provide these types of services; and
r. purchasers make secure payments on the online website system for goods and/or services sold by suppliers.

2. An enhanced negotiation online website system and method where purchasers and suppliers can locate, openly negotiate, purchase and sell goods and/or services of claim 1 where the online website system has a mechanism(s) for the purchaser to make a down payment, a security deposit held and/or show proof of funds available on proposed purchased goods and/or services by the request of the supplier(s) and/or offered by the purchaser.
